(19) United States
(12) Patent Application Publication
(10) Pub. No.: US 2007/0111038 A1
(43) Pub. Date: May 17, 2007

(54) Magnetic recording medium

(75) Inventors: Jun Koujima, Hatsukaichi-shi (JP); Teruaki Santoki, Hatsukaichi-shi (JP); Takanori Doi, Hatsukaichi-shi (JP)

Correspondence Address: NIXON & VANDERHYE, PC, 901 NORTH GLEBE ROAD, 11TH FLOOR, ARLINGTON, VA, 22203, US

(73) Assignee: Toda Kogyo Corporation, Hiroshima-shi (JP)

(21) Appl. No.: 11/273,607

(22) Filed: Nov. 15, 2005

(51) Int. Cl. G11B 5/65

(52) U.S. Cl. 428/836.1

(57) ABSTRACT

A magnetic recording medium comprises a polymer film substrate having an elongated shape or a polymer flexible substrate; an underlayer having a thickness of less than 10 nm, which is formed on the substrate; and a magnetic recording layer comprising a spinel iron oxide thin film containing maghemite as a main component, which is formed on the underlayer and has a coercive force of not less than 159 kA/m (2000 Oe). The present invention provides the magnetic recording medium comprising a spinel iron oxide thin film containing maghemite as a main component, which exhibits an excellent recording resolution performance while maintaining a high coercive force and a high coercive force squareness.

### BACKGROUND OF THE INVENTION

The present invention relates to a magnetic recording medium, and more particularly, to a magnetic recording medium exhibiting excellent magnetic properties and recording resolution performance. The magnetic recording medium of the present invention can be suitably used as in-plane magnetic recording media (longitudinal magnetic recording media) such as magnetic tapes and flexible disks.

In recent years, there has been a remarkable tendency that magnetic tapes or magnetic recording media using a flexible substrate are also required to have a large capacity as well as a high reliability similarly to other recording media. With such a recent tendency, in order to deal with a large capacity data, it has been required to provide magnetic recording media on which information can be stored with a high density. Further, with a variety of applications of these magnetic recording media, it has been increasingly demanded that the magnetic recording media exhibit a good archive property, i.e., a less deterioration in quality of data signals recorded therein.

In order to satisfy such requirements, the magnetic recording media have been strongly required to have not only excellent magnetic properties such as a high coercive force, but also inhibit deterioration in magnetic properties thereof under various environmental conditions.

As magnetic recording media having a high coercive force, there is widely known those magnetic recording media comprising a substrate and a magnetic thin film formed on the substrate.

The magnetic thin films which have been already practically applied to magnetic recording media, are generally classified into magnetic oxide thin films made of maghemite or the like (“Technical Report of Electronic Telecommunication Institute”, published by Electronic Telecommunication Institute, (1981) MR 81-20, pp. 5 to 12; “Ceramics”, published by Japan Institute of Ceramics, (1986) Vol. 24, No. 1, pp. 21 to 24; and Japanese Patent Publication (KOKOKU) Nos. 51-4086(1976) and 5-63925(1993)), and magnetic alloy thin films made of Co—Cr alloy or the like.

The magnetic oxide thin films are excellent in oxidation resistance or corrosion resistance due to inherent properties of the oxides. As a result, the magnetic oxide thin films can show an excellent stability independent of the passage of time, and a less change in magnetic properties with the passage of time. Further, the magnetic oxide thin films exhibit a high hardness by themselves and, therefore, have an excellent durability.

On the other hand, the magnetic alloy thin films have a coercive force as high as not less than about 159 kA/m (2000 Oe). However, the alloy materials themselves tend to be readily oxidized and, as a result, tend to be deteriorated in stability independent of the passage of time as well as magnetic properties.

Conventionally, there are known magnetic recording media comprising a substrate such as a glass substrate, an underlayer such as an NiO layer which is formed on the substrate, and a Co-containing maghemite thin film formed on the underlayer (Japanese Patent Application Laid-Open (KOKAI) Nos. 2001-250216 and 2003-203324). Also, there are known magnetic recording media comprising a plastic substrate made of polyamides, polyimides or the like, and a Co-containing maghemite thin film formed on the substrate (Japanese Patent Application Laid-Open (KOKAI) Nos. 2004-47009, 2004-158131 and 2004-199801).

At present, it has been strongly demanded to provide magnetic recording media comprising a polymer film or a polymer flexible film as a substrate, and a spinel iron oxide thin film containing maghemite as a main component, which are capable of exhibiting not only a high coercive force and a high squareness but also an excellent recording resolution performance. However, such magnetic recording media satisfying these requirements have not been obtained until now.

That is, in Japanese Patent Application Laid-Open (KOKAI) No. 2001-250216, although there is described the magnetic recording medium comprising a glass substrate, an NiO underlayer layer formed on the glass substrate, and a Co-containing maghemite thin film formed on the underlayer layer, the thickness of the underlayer layer is as large as more than 10 nm, so that it may be difficult to sufficiently control a crystal orientation of the magnetic recording layer, thereby failing to exhibit excellent magnetic properties.

Also, in Japanese Patent Application Laid-Open (KOKAI) No. 2004-47009, although the cobalt-containing maghemite thin film described herein is formed on the NiO underlayer, the thickness of the underlayer is as large as more than 10 nm, so that it may be difficult to sufficiently control a crystal orientation of the magnetic recording layer, thereby failing to exhibit excellent magnetic properties. Further, in the case where the underlayer has such a large thickness, the magnetic thin film layer tends to suffer from defects such as cracks due to stress caused by the difference in coefficient of thermal expansion therebetween depending upon kinds of underlayer and substrate used.

The cobalt-containing maghemite thin film described in Japanese Patent Application Laid-Open (KOKAI) Nos. 2004-158131 and 2004-199801 is provided with no underlayer, and, therefor, may fail to be suitably controlled in crystal orientation thereof and exhibit good magnetic properties due to the well-controlled crystal orientation.

Further, in Japanese Patent Application Laid-Open (KOKAI) No. 2003-203324, it is described that the cobalt-containing maghemite thin film is improved in magnetic properties by providing an orientation-controlling layer having a thickness of less than 10 nm and allowing a (400) crystal plane of the thin film to be oriented in parallel with the surface of the substrate. However, since the aimed magnetic recording medium of this KOKAI is a perpendicular magnetic recording medium, the control of the crystal orientation, the internal stress of the film as well as production of the in-plane magnetic recording media by controlling the stress are not taken into consideration at all.

As a result of the present inventors' earnest study for solving the above problems, it has been found that by providing an underlayer to control a crystal orientation of a spinel iron oxide layer containing maghemite as a main component, the magnetic recording medium produced even by a low-temperature process having a limited temperature range can exhibit excellent magnetic properties while maintaining a high coercive force and a high squareness. The present invention has been attained based on the above finding.

### SUMMARY OF THE INVENTION

An object of the present invention is to provide a magnetic recording medium comprising a spinel iron oxide thin film containing maghemite as a main component which can exhibit an excellent recording resolution performance while maintaining a high coercive force and a high squareness.

Namely, according to the present invention, there is provided the magnetic recording medium comprising a polymer film substrate or a polymer flexible substrate, and a spinel iron oxide thin film containing maghemite as a main component which is formed on the substrate and has an excellent recording resolution performance, wherein the magnetic recording medium can exhibit excellent magnetic properties while maintaining a high coercive force and a high squareness by controlling a crystal orientation of the spinel iron oxide layer containing maghemite as a main component by means of an underlayer formed thereunder, even when produced by a low-temperature process having a limited temperature range.

To accomplish the aim, in a first aspect of the present invention, there is provided a magnetic recording medium comprising a polymer film substrate having an elongated shape; an underlayer having a thickness of less than 10 nm, which is formed on the substrate; and a magnetic recording layer comprising a spinel iron oxide thin film containing maghemite as a main component which is formed on the underlayer and has a coercive force of not less than 159 kA/m (2000 Oe).

In a second aspect of the present invention, there is provided a magnetic recording medium comprising a polymer flexible substrate; an underlayer having a thickness of less than 10 nm, which is formed on the substrate; and a magnetic recording layer comprising a spinel iron oxide thin film containing maghemite as a main component which is formed on the underlayer and has a coercive force of not less than 159 kA/m (2000 Oe).

In a third aspect of the present invention, there is provided the magnetic recording medium according to the above first or second aspect, wherein the magnetic recording layer has a coercive force squareness (S*) of not less than 0.7.

In a fourth aspect of the present invention, there is provided the magnetic recording medium according to the above first or second aspect, wherein a ratio (Mᵣ^{⊥}/Mᵣ^{//}) of a residual magnetization (Mᵣ^{⊥}) obtained when magnetized in a direction perpendicular to a film surface of the magnetic recording layer to a residual magnetization (Mᵣ^{//}) obtained when magnetized in an in-plane direction of the magnetic recording layer, is not more than 0.5.

In a fifth aspect of the present invention, there is provided the magnetic recording medium according to the above first or second aspect, wherein a ratio (Hc^{⊥}/Hc^{//}) of a coercive force (Hc^{⊥}) obtained when magnetized in a direction perpendicular to a film surface of the magnetic recording layer to a coercive force (Hc^{//}) obtained when magnetized in an in-plane direction of the magnetic recording layer, is not more than 0.5.

### DETAILED DESCRIPTION OF THE INVENTION

The present invention is described in detail below.

First, the magnetic recording medium of the present invention is described.

Examples of materials of the polymer film substrate or the polymer flexible substrate used in the present invention may include polyamides, polyimides, polyamide imides, polyether ketones, polyether sulfones, polyether imides, polysulfones, polyphenylene sulfides, triacetate cellulose, polyethylene terephthalate, polyethylene naphthalate, polyesters, polycarbonates, polyacrylates, polyacrylonitrile, polyvinyl alcohol, polystyrene, polyethylene, polypropylene, polyvinyl chloride, polyvinylidene chloride, polybutylene naphthalate, polyalkylene resins, fluororesins, p-phenylenebenzobisoxazole or the like. The thickness, surface roughness, shape of fine protrusions, etc., of the substrate may be appropriately determined according to kinds of materials used therefor as long as a sufficient contact of the substrate with a magnetic head can be ensured. In addition, the polymer film substrate or the polymer flexible substrate may be provided on the surface thereof with a primer coat layer comprising materials having an excellent heat resistance, such as polyimide resins, polyamide imide resins, silicone resins, fluororesins or the like, in order to enhance a surface smoothness or a gas-barrier property of the substrate.

The underlayer used in the present invention may be in the form of an oxide thin film having an NaCl-type structure. Specific examples of the NaCl-type oxide thin film may include AmO thin film, BaO thin film, CaO thin film, CdO thin film, CeO thin film, CoO thin film, EuO thin film, FeO thin film, MgO thin film, MnO thin film, NdO thin film, NiO thin film, NpO thin film, SmO thin film, SrO thin film, TiO thin film, VO thin film, YbO thin film or the like. Of these thin films, preferred are MgO thin film, NiO thin film, CoO thin film, MnO thin film or the like.

The thickness of the underlayer is from more than 0 nm to less than 10 nm, preferably 1 to 9 nm. When no underlayer is provided, the magnetic recording layer tends to be deteriorated in coercive force or coercive force squareness. When the thickness of the underlayer is not less than 10 nm, the magnetic recording layer tends to be deteriorated in crystal orientation, or tends to be deteriorated in magnetic properties or surface properties because the magnetic layer may suffer from cracks, etc., due to its internal stress caused by the difference in coefficient of thermal expansion therebetween.

The spinel iron oxide containing maghemite as a main component which constitutes the magnetic recording layer used in the present invention is represented by the general formula: γ-Fe₂O₃, and may also contain a small amount of Fe²⁺.

Further, the spinel iron oxide containing maghemite as a main component preferably further contains cobalt in order to enhance a coercive force thereof. The amount of cobalt contained in the spinel iron oxide is usually not more than 20% by weight, preferably 1 to 15% by weight based on the weight of Fe. When the cobalt content is less than 1% by weight, it may be difficult to readily obtain a magnetic recording medium having a coercive force as high as not less than 159 kA/m (2,000 Oe). When the cobalt content is more than 20% by weight, it may be difficult to obtain a magnetic recording medium having an excellent stability independent of the passage of time.

Meanwhile, the spinel iron oxide thin film containing maghemite as a main component may also contain, if required, in addition to cobalt, at least one element selected from the group consisting of B, C, Cr, Cu, Mn, Ni, Ti and Zn which can be ordinarily used for improving various properties in such an amount that a molar ratio of the element to Fe is usually about 0.005 to 0.04. When the above different kinds of elements are incorporated in the spinel iron oxide thin film containing maghemite as a main component, production of the magnetic recording medium having a high coercive force and a high coercive force squareness can be facilitated.

The thickness of the magnetic recording layer constituted by the spinel iron oxide thin film containing maghemite as a main component is usually 5 to 100 nm, preferably 10 to 100 nm. When the thickness of the magnetic recording layer is less than 5 nm, it may be difficult to readily obtain a magnetic recording medium having a high coercive force and a high coercive force squareness. When the thickness of the magnetic recording layer is more than 100 nm, it may be difficult to uniformly magnetize the magnetic layer up to a deep portion thereof upon recording signals thereon, resulting in large media noises.

The magnetic recording medium of the present invention has a coercive force value of usually not less than 159 kA/m (2,000 Oe), preferably 199 to 1194 kA/m (2500 to 10000 Oe); and a saturation magnetization value (value of magnetization when applying a magnetic field of 1590 kA/m (20 kOe) thereto) of usually 29 to 53 Wb/m³ (230 to 420 emu/cm³), preferably 30 to 53 Wb/m³ (240 to 420 emu/cm³).

The spinel iron oxide thin film containing maghemite as a main component has a coercive force squareness S* value of usually not less than 0.70. When the coercive force squareness S* value is less than 0.70, the thin film tends to be deteriorated in recording and reproduction properties such as overwrite property and, therefore, tends to be unsuitable for magnetic recording media.

In the spinel iron oxide thin film containing maghemite as a main component, the ratio (Mᵣ^{⊥}/Mᵣ^{//}) of a residual magnetization (Mᵣ^{⊥}) obtained when magnetized in a direction perpendicular to the surface of the thin film to a residual magnetization (Mᵣ^{//}) obtained when magnetized in an in-plane direction thereof is usually not more than 0.5. When the ratio (Mᵣ^{⊥}/Mᵣ^{//}) is more than 0.5, the spinel iron oxide thin film tends to be deteriorated in recording and reproduction properties such as signal properties (noise properties) and, therefore, tends to be unsuitable for magnetic recording media.

In the spinel iron oxide thin film containing maghemite as a main component, the ratio of (Hc^{⊥}/Hc^{//}) a coercive force (Hc^{⊥}) obtained when magnetized in a direction perpendicular to the surface of the thin film to a coercive force (Hc^{//}) obtained when magnetized in an in-plane direction thereof is usually not more than 0.5. When the ratio (Hc^{⊥}/Hc^{//}) is more than 0.5, the spinel iron oxide thin film tends to be deteriorated in recording and reproduction properties such as signal properties (noise properties) and, therefore, tends to be unsuitable for magnetic recording media.

The magnetic recording medium of the present invention has an electric resistance value of usually 0.01 to 100 MΩ, preferably 0.1 to 20 MΩ. When the electrical resistance value is less than 0.01 MΩ, a large amount of cobalt-containing magnetite tends to remain in the spinel iron oxide thin film containing maghemite as a main component, thereby failing to obtain a magnetic recording medium having a high coercive force.

Next, the process for producing the magnetic recording medium according to the present invention is described.

The magnetic recording medium of the present invention can be produced by successively forming the underlayer and the spinel iron oxide thin film containing maghemite as a main component on the substrate by a sputtering method. For example, the magnetic recording medium of the present invention can be produced by any of the following methods:

(1) A method of successively forming the underlayer and a cobalt-containing magnetite thin film on the substrate by a sputtering method, and then heat-treating the magnetite thin film in atmospheric air at a temperature of usually 200 to 250° C. to transform the magnetite thin film into the spinel iron oxide thin film containing maghemite as a main component;

(2) a method of successively forming the underlayer and the cobalt-containing magnetite thin film on the substrate by a sputtering method, and then continuously sputter-treating the magnetite thin film in an oxygen-rich atmosphere in the same sputtering chamber without taking out into atmospheric air to transform the magnetite thin film into the spinel iron oxide thin film containing maghemite as a main component; and

(3) a method of successively forming the underlayer and the cobalt-containing magnetite thin film on the substrate by a sputtering method, and then continuously irradiating a plasma produced in a mixed gas atmosphere composed of a rare gas (such as He, Ne, Ar, Kr, Xe and Re) and an oxygen gas, to the magnetite thin film in the same sputtering chamber without taking out into atmospheric air to transform the magnetite thin film into the spinel iron oxide thin film containing maghemite as a main component.

The sputtering apparatus usable in the present invention is not particularly limited, and there may be used any of conventionally known sputtering apparatuses which have been generally used for performing the sputtering method.

In the above methods (1) to (3), the formation of the cobalt-containing magnetite thin film may be similarly conducted.

The cobalt-containing magnetite thin film may be formed by the following method. That is, using a sputtering apparatus including a target, a can roll, a vacuum chamber, etc., an Fe metal or Fe alloy target is sputtered while introducing a mixed gas composed of oxygen and a rare gas, and controlling an oxygen flow rate (CCM) in the mixed gas as well as a deposition rate (nm/s) of cobalt-containing magnetite to form the cobalt-containing magnetite thin film on the underlayer.

The oxygen flow rate (CCM) in the mixed gas may be controlled for achieving a suitable deposition rate (nm/s) of cobalt-containing magnetite by appropriately selecting various conditions used for obtaining the cobalt-containing magnetite thin film by sputtering the Fe metal or Fe alloy target, for example, kind and structure of sputtering apparatus used, roll speed, film deposition rate, total gas pressure, substrate temperature, surface area of sputtering target, etc.

In the above method (1), after forming the cobalt-containing magnetite thin film, the thus obtained cobalt-containing magnetite thin film is taken out into atmospheric air, and then heat-treated in atmospheric air at a temperature of usually 200 to 250° C. while adjusting the roll speed.

The oxygen-rich atmosphere used upon forming the spinel iron oxide thin film containing maghemite as a main component in the above method (2) is an atmosphere having an oxygen partial pressure of such a range in which the surface of the Fe metal or Fe alloy target is oxidized, and the film deposition rate of the cobalt-containing magnetite is considerably decreased. At this time, the cathode current value is considerably increased as compared to the condition where the surface of the target is not oxidized, whereas the voltage value thereof is considerably decreased. In general, under such a condition that the surface of the Fe metal or Fe alloy target is oxidized, an iron oxide film is formed on the surface of the target, so that it may be difficult to deposit cobalt-containing magnetite. On the other hand, in the present invention, it is considered that by conducting the sputtering treatment in such an oxygen-rich atmosphere, iron oxide or iron ions are driven out from the target.

More specifically, the oxygen-rich atmosphere in the sputtering film-forming apparatus used in the present invention, is an atmosphere satisfying the condition represented by the formula:
F_{O2}/R≧12
wherein F_{O2} is an oxygen flow rate (CCM) in oxidation treatment; and R is a deposition rate (nm/s) of cobalt-containing magnetite.

For example, in the case of R=2.0 (nm/s), the oxygen flow rate (F_{O2}) capable of oxidizing the target is not less than 24 (CCM).

Also, in the case of R=1.0 (nm/s), the oxygen flow rate (F_{O2}) capable of oxidizing the surface of the target is not less than 12 (CCM).

In the present invention, the sputtering treatment in the oxygen-rich atmosphere for depositing the cobalt-containing magnetite thin film on the substrate is conducted at a substrate temperature of usually 30 to 250° C., preferably 50 to 150° C. When the substrate temperature is out of the above-specified range, it may be difficult to sufficiently attain effects of the present invention.

In the method (3), the oxidation treatment in which a plasma produced in a mixed gas atmosphere composed of a rare gas (such as He, Ne, Ar, Kr, Xe and Re) and an oxygen gas is irradiated onto the substrate may be conducted, for example, by such a method using an ECR micro-plasma. The irradiation condition is usually classified into two types, i.e., ashing mode and etching mode. In general, the ashing mode is suitable for surface modification treatment because an ion beam emitted from a plasma production chamber is directly irradiated to the substrate while being kept in an ionized state. On the other hand, the etching mode is effective for etching treatment because an ion beam emitted from the plasma production chamber is increased in intensity and amount by neutralizing a space charge using a neutralizer.

In the present invention, it has been confirmed that when the plasma irradiation is conducted while adjusting an ion acceleration voltage under such a condition that the thickness of the cobalt-containing magnetite thin film is not reduced due to etching, the thin film can be suitably oxidized in any of the ashing and etching modes.

In the present invention, the plasma irradiation treatment upon oxidation of the cobalt-containing magnetite thin film is conducted at a substrate temperature of usually 30 to 250° C., preferably 50 to 150° C. When the substrate temperature is out of the above-specified range, it may be difficult to sufficiently attain effects of the present invention. In the method (3), the oxidation treatment may be conducted by irradiating plasma while adjusting the roll speed to the same speed as used in the methods (1) and (2).

In the magnetic recording media obtained by the above methods (1) to (3), the magnetic recording layer may be provided thereon with a protective layer made of silica, alumina, titania, zirconia, titanium nitride, silicon nitride, boron nitride, carbon or diamond-like carbon in order to enhance a sliding property of a magnetic head or reduce abrasion of the magnetic head. The thickness of the protective layer may be appropriately determined in such a range in which an extreme increase in magnetic spacing between the magnetic head and the magnetic recording layer is avoided, and the magnetic head is stably traveled. Further, the protective layer may be coated with a lubricant such as a hydrocarbon-based lubricant, a fluorine-based lubricant and an extreme pressure additive.

Examples of the hydrocarbon-based lubricant may include carboxylic acids, esters, sulfonic acids, phosphates, alcohols, caboxamides, amines or the like.

Examples of the fluorine-based lubricant may include lubricants obtained by replacing a part or whole of alkyl groups of the above hydrocarbon-based lubricant with a fluoroalkyl group or a perfluoropolyether group. Specific examples of the perfluoropolyether group may include groups derived from perfluoromethylene oxide polymers, perfluoroethylene oxide polymers, perfluoro-n-propylene oxide polymers, perfluoroisopropylene oxide polymers, or copolymers thereof.

Examples of the extreme pressure additive may include esters of phospholic acid, esters of phosphilic acid, esters of thiophosphilic acid, esters of thiophospholic acid and sulfur-based extreme pressure agent.

The above lubricants may be used singly or in combination of a plurality of these lubricant. Upon coating the protective layer with the lubricant, a solution prepared by dissolving the lubricant in an organic solvent may be applied onto the surface of the protective layer by a spin coating method, a wire bar coating method, a gravure coating method, a dip coating method or the like.

When the magnetic recording medium is used as a magnetic tape, a back coat layer containing carbon is preferably provided on the surface opposite to the magnetic layer-forming surface, thereby suitably controlling a surface smoothness and a friction coefficient of the magnetic tape, and preventing undesirable electrification thereof.

When the magnetic recording medium is used as a flexible magnetic disk, a raw plate produced by successively forming a primer layer, an underlayer, a magnetic recording layer, a protective layer, etc., on both surfaces of a substrate is blanked into a shape of disk used, coated with a lubricant, and then polished with a polishing tape, thereby producing the flexible magnetic disk.

The point of the present invention is that when a (400) crystal plane of the magnetic recording layer comprising the spinel iron oxide thin film containing maghemite as a main component is controlled to be oriented in parallel with the surface of the substrate, the resultant magnetic recording medium can exhibit excellent magnetic properties.

Conventionally, when producing a maghemite thin film by subjecting a magnetite thin film to oxidation treatment, it has been required to conduct the oxidation treatment at a high temperature. However, since the oxidation treatment temperature is higher than a heat-resisting temperature of ordinary polymer films or flexible substrates, only limited substrates are usable therein. On the contrary, in the present invention, the (400) crystal plane of the spinel iron oxide thin film containing maghemite as a main component which constitutes the magnetic recording layer is oriented in parallel with the surface of the substrate so as to generate a compression stress in an in-plane direction thereof, so that a large magnetic anisotropy can be induced even in a low-temperature process, thereby enabling many kinds of substrates to be used without particular limitations.

Conventionally, when the spinel iron oxide thin film is used in perpendicular magnetic recording media, the (400) crystal plane of the spinel iron oxide is oriented in the direction parallel with the surface of the substrate so as to generate a tensile stress in an in-plane direction of the thin film. The reason therefor is that as a result of a thermal stress generated due to the difference in coefficient of thermal expansion between the substrate and the thin film as well as an internal stress which is varied according to sputtering film-forming conditions, etc., the tensile stress is generated in the in-plane direction of the thin film, so that the thus produced spinel iron oxide thin film having a large negative magnetostrictive constant can exhibit a perpendicular magnetic anisotropy. On the contrary, in the present invention, although the (400) crystal plane is oriented in the direction parallel with the surface of the substrate similarly to the conventional recording media, the film-forming conditions are controlled such that the stress generated in an in-plane direction of the spinel iron oxide thin film is finally a compression stress, whereby a large magnetic anisotropy can be produced in the in-plane direction. Accordingly, the magnetic recording medium of the present invention can be suitably used as a high-density in-plane magnetic recording medium (high-density longitudinal magnetic recording medium).

In addition, the surface properties of the magnetic recording layer depend upon those of the substrate. Since the magnetic recording medium of the present invention is produced by a low-temperature process, the surface properties of the substrate used can be maintained substantially without any change. Therefore, by using a substrate having suitable surface properties, it becomes possible to obtain a magnetic recording medium exhibiting desired surface properties.

Further, according to the above production methods (2) and (3), since the production process is conducted at a temperature as low as usually not more than 150° C., it is possible to use a polymer film substrate or a polymer flexible substrate made of polyethylene terephthalate, polyethylene naphthalate, etc., which has not been usable in the conventional production processes.

The magnetic recording medium of the present invention exhibits excellent magnetic properties as well as enhanced recording resolution performance and, therefore, can be suitably used as high-density recording magnetic tape media or high-density flexible magnetic disk media.

### EXAMPLES

The present invention is described in more detail by Examples and Comparative Examples, but the Examples are only illustrative and, therefore, not intended to limit the scope of the present invention.

Various properties were measured by the following methods.

(1) The thickness of each of the cobalt-containing magnetite thin film, the magnetic layer comprising the spinel iron oxide thin film containing maghemite as a main component, the underlayer, etc., was measured as follows. That is, before the film-forming step, a line was drawn with a magic pen on a substrate. Then, after the film-forming step, the drawn line and the film deposited thereon were simultaneously removed using an organic solvent. The thus formed stepped portion was measured by an atomic force microscope (AFM). The thickness of the thin film was calculated from the measured value.

(2) The oxidation of the cobalt-containing magnetite thin film into the spinel iron oxide thin film containing maghemite as a main component was confirmed by measuring the change in surface resistivity as one of indices therefor.

That is, the surface resistivity of the cobalt-containing magnetite thin film is 0.01 to 10 kΩ, whereas the surface resistivity of the containing maghemite as a main component is increased and changed in the range of 0.01 to 100 MΩ. The surface resistivity of the respective thin films was measured by an Insulation Tester DM-1527 (manufactured by SANWA DENKI KEIKI CO., LTD.) by setting the distance between two probes to 10 mm.

(3) The magnetic properties were evaluated by the value measured using “Vibration Sample Type Magnetometer VSM” (manufactured by TOEI KOGYO CO., LTD.) by applying a maximum magnetic field of 1590 kA/m (20 kOe).

### Example 1

### Production of Magnetic Recording Medium

MgO Underlayer:

The sintered MgO target was sputtered in an argon atmosphere having a total pressure of 0.094 Pa, thereby forming an MgO thin film having a thickness of 2.5 nm at a deposition rate of 0.03 nm/s on an aromatic polyamide (aramid) film substrate.

Cobalt-containing Magnetite:

Next, a metal alloy (Fe+5 wt % Co) target was sputtered on the thus obtained underlayer in an atmosphere containing oxygen and argon and having an oxygen flow rate of 22 CCM, an oxygen partial pressure of 0.03 Pa and a total pressure of 0.38 Pa, thereby forming a cobalt-containing magnetite thin film having a thickness of 50 nm at a deposition rate of 2 nm/s on the underlayer.

Oxidation in Atmospheric Air:

The thus obtained film was passed through an electric furnace in atmospheric air at 230° C. at a roll speed of 2.5 m/min to subject the film to oxidation treatment, thereby forming a spinel iron oxide thin film containing maghemite as a main component.

As a result, it was confirmed that the thus obtained spinel iron oxide thin film containing maghemite as a main component had a thickness of 50 nm, a coercive force of 341.3 kA/m (4289 Oe), and a coercive force squareness (S*) of 0.75.

### Examples 2 to 12 and Comparative Examples 1 to 5

The same procedure as defined in Example 1 was conducted except that the kind of substrate, the kind and thickness of the underlayer, the amount of cobalt used upon formation of the cobalt-containing magnetite thin film, oxygen flow rate and thickness thereof, treating temperature used upon transformation into the spinel iron oxide thin film containing maghemite as a main component were changed variously, thereby obtaining magnetic recording media.

Essential production conditions are shown in Table 1, and various properties of the obtained magnetic recording media are shown in Table 2.

Meanwhile, in Comparative Example 1, the cobalt-containing magnetite thin film was formed by the same method as defined in Example 1 except that no underlayer made of an oxide having an NaCl-type structure was provided, and then subjected to oxidation treatment, thereby obtaining a magnetic recording medium. In Comparative Examples 2, 3 and 4, the same procedure as defined in Example 1 was conducted except that the thickness of the underlayer was changed to 10 nm, 20 nm and 30 nm, respectively, thereby obtaining magnetic recording media. In Comparative Example 5, the same procedure as defined in Example 1 was conducted except that the oxidation treatment was omitted, thereby obtaining a magnetic recording medium.

### Example 10 (Production of Magnetic Recording Medium by the Method (2))

The obtained film was successively treated within the same apparatus by sputtering a metal alloy (Fe+3 wt % Co) target at 70° C. in an oxygen-rich atmosphere containing oxygen and argon and having an oxygen flow rate of 74 CCM, an oxygen partial pressure of 0.12 Pa and a total pressure of 0.40 Pa, thereby obtaining a magnetic recording medium having the spinel iron oxide thin film containing maghemite as a main component.

### Example 11 (Production of Magnetic Recording Medium by the Method (3))

The obtained film was continuously treated within the same apparatus by irradiating a plasma at 70° C. in a mixed gas atmosphere containing helium and oxygen at a mixing ratio of 1:1 under a total pressure of 0.040 Pa at a microwave electric power of 100 W and an ion acceleration voltage of 150V, thereby obtaining a magnetic recording medium having the spinel iron oxide thin film containing maghemite as a main component.

TABLE 1

| | |
|---|---|
| | Kind |
| Examples and | of underlayer |

| Comparative | | | Thickness |
|---|---|---|---|
| Examples | Kind of substrate | Kind | (nm) |
| Example 1 | Polyamide | MgO | 2.5 |
| Example 2 | Polyamide | MgO | 2.5 |
| Example 3 | Polyamide | MgO | 2.5 |
| Example 4 | Polyamide | MgO | 2.5 |
| Example 5 | Polyamide | MgO | 2.5 |
| Example 6 | Polyamide | MgO | 5.0 |
| Example 7 | Polyamide | MgO | 8.0 |
| Example 8 | Polyamide | MgO | 2.5 |
| Example 9 | Polyamide | MgO | 2.5 |
| Example 10 | PET | MgO | 2.5 |
| Example 11 | PET | MgO | 2.5 |
| Example 12 | Polyamide | NiO | 2.5 |
| Comparative | Polyamide | — | — |
| Example 1 | | | |
| Comparative | Polyamide | MgO | 10.0 |
| Example 2 | | | |
| Comparative | Polyamide | MgO | 20.0 |
| Example 3 | | | |
| Comparative | Polyamide | MgO | 30.0 |
| Example 4 | | | |
| Comparative | Polyamide | MgO | 2.5 |
| Example 5 | | | |

| | Film-forming conditions | | |
|---|---|---|---|
| | of recording layer | | |
| Examples and | | Oxygen flow | Substrate |
| Comparative | Co content | rate | temperature |
| Examples | (wt %) | (CCM) | (° C.) |
| Example 1 | 5 | 22 | R.T.* |
| Example 2 | 3 | 22 | R.T. |
| Example 3 | 8 | 22 | R.T. |
| Example 4 | 12 | 22 | R.T. |
| Example 5 | 15 | 22 | R.T. |
| Example 6 | 5 | 22 | R.T. |
| Example 7 | 5 | 22 | R.T. |
| Example 8 | 5 | 22 | R.T. |
| Example 9 | 5 | 22 | R.T. |
| Example 10 | 5 | 22 | R.T. |
| Example 11 | 5 | 22 | R.T. |
| Example 12 | 5 | 22 | R.T. |
| Comparative | 5 | 22 | R.T. |
| Example 1 | | | |
| Comparative | 5 | 22 | R.T. |
| Example 2 | | | |
| Comparative | 5 | 22 | R.T. |
| Example 3 | | | |
| Comparative | 5 | 22 | R.T. |
| Example 4 | | | |
| Comparative | 5 | 22 | R.T. |
| Example 5 | | | |

| | |
|---|---|
| Examples and | Oxidation treatment |

| Comparative | Oxidation treatment | Treating temperature |
|---|---|---|
| Examples | process | (° C.) |
| Example 1 | Heat treatment in air | 230 |
| Example 2 | Heat treatment in air | 230 |
| Example 3 | Heat treatment in air | 230 |
| Example 4 | Heat treatment in air | 230 |
| Example 5 | Heat treatment in air | 230 |
| Example 6 | Heat treatment in air | 230 |
| Example 7 | Heat treatment in air | 230 |
| Example 8 | Heat treatment in air | 230 |
| Example 9 | Heat treatment in air | 230 |
| Example 10 | Sputtering in oxygen- | 70 |
| | rich atmosphere | |
| Example 11 | Plasma irradiation | 70 |
| Example 12 | Heat treatment in air | 230 |
| Comparative | Heat treatment in air | 230 |
| Example 1 | | |
| Comparative | Heat treatment in air | 230 |
| Example 2 | | |
| Comparative | Heat treatment in air | 230 |
| Example 3 | | |
| Comparative | Heat treatment in air | 230 |
| Example 4 | | |
| Comparative | — | — |
| Example 5 | | |

Note
*R.T. = room temperature

TABLE 2

| | Properties of magnetic | | |
|---|---|---|---|
| | recording medium | | |
| Examples and | Thickness of | Thickness of | |
| Comparative | underlayer | recording layer | Co content |
| Examples | (nm) | (nm) | (wt %) |
| Example 1 | 2.5 | 50 | 5 |
| Example 2 | 2.5 | 50 | 3 |
| Example 3 | 2.5 | 50 | 8 |
| Example 4 | 2.5 | 50 | 12 |
| Example 5 | 2.5 | 50 | 15 |
| Example 6 | 5 | 50 | 5 |
| Example 7 | 8 | 50 | 5 |
| Example 8 | 2.5 | 25 | 5 |
| Example 9 | 2.5 | 100 | 5 |
| Example 10 | 2.5 | 50 | 5 |
| Example 11 | 2.5 | 50 | 5 |
| Example 12 | 2.5 | 50 | 5 |
| Comparative | — | 50 | 5 |
| Example 1 | | | |
| Comparative | 10 | 50 | 5 |
| Example 2 | | | |
| Comparative | 20 | 50 | 5 |
| Example 3 | | | |
| Comparative | 30 | 50 | 5 |
| Example 4 | | | |
| Comparative | 2.5 | 50 | 5 |
| Example 5 | | | |

| | Properties of magnetic | | |
|---|---|---|---|
| | recording medium | | |
| Examples | Magnetic properties | | |
| and | | Coercive force | Coercive force |
| Comparative | | (Hc) | squareness |

| Examples | (kA/m) | (Oe) | (S*) |
|---|---|---|---|
| Example 1 | 341.3 | 4289 | 0.75 |
| Example 2 | 217.6 | 2734 | 0.80 |
| Example 3 | 347.0 | 4361 | 0.74 |
| Example 4 | 513.8 | 6456 | 0.73 |
| Example 5 | 290.5 | 3651 | 0.71 |
| Example 6 | 266.7 | 3351 | 0.71 |
| Example 7 | 239.8 | 3014 | 0.70 |
| Example 8 | 410.8 | 5162 | 0.79 |
| Example 9 | 245.7 | 3088 | 0.73 |
| Example 10 | 227.0 | 2852 | 0.70 |
| Example 11 | 243.2 | 3056 | 0.73 |
| Example 12 | 288.2 | 3622 | 0.71 |
| Comparative | 127.0 | 1596 | 0.58 |
| Example 1 | | | |
| Comparative | 237.5 | 2984 | 0.69 |
| Example 2 | | | |
| Comparative | 184.7 | 2321 | 0.66 |
| Example 3 | | | |
| Comparative | 161.6 | 2031 | 0.62 |
| Example 4 | | | |
| Comparative | 17.0 | 214 | 0.21 |
| Example 5 | | | |

| | Properties of magnetic | | |
|---|---|---|---|
| Examples | recording medium | | |
| and | | Magnetic properties | Surface |

| Comparative | Mᵣ ratio | H_{c} ratio | resistivity |
|---|---|---|---|
| Examples | (Mᵣ^{⊥}/Mᵣ^{//}) | (H_{c}^{⊥}/H_{c}^{//}) | (MΩ) |
| Example 1 | 0.35 | 0.40 | 1.20 |
| Example 2 | 0.28 | 0.38 | 0.94 |
| Example 3 | 0.33 | 0.45 | 0.62 |
| Example 4 | 0.42 | 0.41 | 1.60 |
| Example 5 | 0.45 | 0.46 | 1.30 |
| Example 6 | 0.38 | 0.46 | 0.85 |
| Example 7 | 0.44 | 0.47 | 0.75 |
| Example 8 | 0.34 | 0.38 | 2.80 |
| Example 9 | 0.41 | 0.48 | 0.28 |
| Example 10 | 0.31 | 0.38 | 0.75 |
| Example 11 | 0.33 | 0.33 | 0.68 |
| Example 12 | 0.43 | 0.45 | 1.40 |
| Comparative | 0.64 | 0.67 | 1.50 |
| Example 1 | | | |
| Comparative | 0.54 | 0.64 | 1.30 |
| Example 2 | | | |
| Comparative | 0.56 | 0.67 | 0.88 |
| Example 3 | | | |
| Comparative | 0.58 | 0.71 | 0.92 |
| Example 4 | | | |
| Comparative | 0.66 | 0.82 | 0.0004 |
| Example 5 | | | |

What is claimed is:

1. A magnetic recording medium, comprising:
a polymer film substrate having an elongated shape or a polymer flexible substrate;
an underlayer having a thickness of less than 10 nm, which is formed on the substrate; and
a magnetic recording layer comprising a spinel iron oxide thin film containing maghemite as a main component, which is formed on the underlayer, said magnetic recording layer having a coercive force of not less than 159 kA/m (2000 Oe).

2. A magnetic recording medium according to claim 1, wherein said magnetic recording layer has a coercive force squareness (S*) of not less than 0.7.

3. A magnetic recording medium according to claim 1, wherein a ratio (Mᵣ⊥/Mᵣ//) of a residual magnetization (Mᵣ⊥) obtained when magnetized in a direction perpendicular to a film surface of the magnetic recording layer to a residual magnetization (Mᵣ//) obtained when magnetized in an in-plane direction of the magnetic recording layer, is not more than 0.5.

4. A magnetic recording medium according to claim 1, wherein a ratio (Hc⊥/Hc//) of a coercive force (Hc⊥) obtained when magnetized in a direction perpendicular to a film surface of the magnetic recording layer to a coercive force (Hc//) obtained when magnetized in an in-plane direction of the magnetic recording layer, is not more than 0.5.

5. A magnetic recording medium according to claim 1, wherein said underlayer has a thickness of 1 to 9 nm.

6. A magnetic recording medium according to claim 1, wherein said spinel iron oxide thin film containing maghemite as a main component contains cobalt in an amount of not more than 20% by weight.

7. A magnetic recording medium according to claim 1, wherein said spinel iron oxide thin film containing maghemite as a main component further contains at least one element selected from the group consisting of B, C, Cr, Cu, Mn, Ni, Ti and Zn.

8. A magnetic recording medium according to claim 1, wherein said magnetic recording layer has a thickness of 5 to 100 nm.

9. A magnetic recording medium according to claim 1, wherein said magnetic recording medium has an electric resistance of 0.01 to 100 MΩ.

10. A magnetic recording medium, comprising:
a polymer film substrate having an elongated shape or a polymer flexible substrate;
an underlayer having a thickness of less than 10 nm, which is formed on the substrate; and
a magnetic recording layer comprising a spinel iron oxide thin film containing maghemite as a main component which is formed on the underlayer, said magnetic recording layer having a coercive force of not less than 159 kA/m (2000 Oe), a coercive force squareness (S*) of not less than 0.7, a ratio (Mᵣ⊥/Mᵣ//) of a residual magnetization (Mᵣ⊥) obtained when magnetized in a direction perpendicular to a film surface of the magnetic recording layer to a residual magnetization (Mᵣ//) obtained when magnetized in an in-plane direction of the magnetic recording layer, of not more than 0.5, and a ratio (Hc⊥/Hc//) of a coercive force (Hc⊥) obtained when magnetized in a direction perpendicular to a film surface of the magnetic recording layer to a coercive force (Hc//) obtained when magnetized in an in-plane direction of the magnetic recording layer, of not more than 0.5.
